(19) United States
(12) Patent Application Publication
(10) Pub. No.: US 2007/0030662 A1
(43) Pub. Date: Feb. 8, 2007

(54) Light power irradiation treatment apparatus

(76) Inventor: Fu-Yu Hsu, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/195,597

(22) Filed: Aug. 3, 2005

(51) Int. Cl. F21V 33/00

(52) U.S. Cl. 362/1; 362/183; 362/2; 362/230; 362/234

(57) ABSTRACT

Light power irradiation treatment apparatus having a cabinet adapted to receive the user's body, a through hole being formed at a top side of the cabinet to allow the user to extending his head out of the cabinet; a plurality of light-emitting diodes (LEDs) emitting light of different wavelength, LEDs being electrically coupled to a circuit substrate to form an irradiation unit, a plurality of irradiation units being mounted on the inner wall of the cabinet, thereby creating at least one planar irradiation light; an LED control circuit adapted to supply power and actuate the light-emitting diodes on the circuit substrate; and a control panel mounted on the surface of the cabinet for selecting a desired irradiation mode to let a certain amount of the light-emitting diodes light up or go out.

### BACKGROUND OF THE INVENTION

1. Field of the Invention

The invention relates to a light power irradiation treatment apparatus, and more particularly, to a light power irradiation treatment apparatus having an irradiation light source with certain wavelengths within a cabinet. The user's body except his head is exposed to the irradiation as if taking a “sunbath”.

2. Description of the Related Art

It's been well-known that light rays are used to treat the dermatosis. One of them is the sunbath. A special treatment effect will be achieved when the skin is exposed to the infrared and ultraviolet in the daylight. However, the daylight is not always available. In addition, some light rays having certain wavelength in the daylight can be harmful to the human body.

With the change of life style, dermal problems have recently focused on the skin disease caused by job stress, dietetic habit or other factors. Hence, it becomes gradually popular to employ Intense Pulsed Light (IPL) to cure the dermal diseases.

The research of Intense Pulsed Light (IPL) began in the year of 1990. The action spectrum of the Intense Pulsed Light (IPL) is very wide und it is the light whose wavelength ranges from 550 nm to 1200 nm. The spectrum of visible light and the infrared light are also included in the spectrum of the Intense Pulsed Light. Compared with the laser beam, the Intense Pulsed Light has the similar energy and wavelength, but the range of its wavelength is larger. Because the skin tissue has different reaction to the absorption and dispersion of different light beams, the system of Intense Pulsed Light (IPL) can select the relevant light to cure the different dermal problems. For example, the light with color from yellow to orange can exert its effect on the red blood vessel in the skin and the red light can remove the pigment.

For the above mentioned characteristics, aiming to the removal of the dermal problems, the Intense Pulsed Light (IPL) can select an arbitrary light with suitable wavelength to carry out the treatment for different dermal problem, such as the expansion of blood vessel (redness-removal), the pigment treatment (spot-removal) and the stimulation of the fabric root cell in the derma (younger treatment) etc. Besides, the treatment results of spots, the uneven pigment, the expansion of blood vessel, the reddish face, the rough skin without flexibility, etc. are also very satisfactory.

Unfortunately, the instrument of the Intense Pulsed Light (IPL) is very expensive and the operation requirements of this instrument are also very high. Hence, a normal little clinic or family can not afford it. Therefore, it's difficult to popularize it.

Accordingly, the invention is aimed at a further research on this topic for an effective breakthrough of the problem caused by the prior art.

### SUMMARY OF THE INVENTION

A primary object of the invention is to provide a light power irradiation treatment apparatus having different operation modes to allow the user to select a desired one. That is, the user can choose one irradiation light source with a certain wave-length to which the user's body except his head is exposed as if taking a “sunbath”.

Another object of the invention is to provide a light power irradiation treatment apparatus that is convenient to operate and safe to use.

A further object of the invention is to provide a light power irradiation treatment apparatus having an anion generator. During exposure of user's body to the light rays, anions can be released in close vicinity to his head for purifying the air and, therefore, refreshing him.

Still another object of the invention is to provide a light power irradiation treatment apparatus having a steam inlet through which the vapor can be fed to the cabinet. Accordingly, the phototherapeutic cabinet of the invention can be used as a spa facility.

In order to achieve the above-mentioned objects, a phototherapy apparatus with the function of change-over to different wavelength comprises:

a) a cabinet adapted to receive the user's body, a through hole being formed at a top side of the cabinet to allow the user to extending his head out of the cabinet;

b) a plurality of light-emitting diodes (LEDs) emitting light of different wavelength, LEDs being electrically coupled to a circuit substrate to form an irradiation unit, a plurality of irradiation units being mounted on the inner wall of the cabinet, thereby creating at least one planar irradiation light;

c) an LED control circuit adapted to supply power and actuate the light-emitting diodes on the circuit substrate; and

d) a control panel mounted on the surface of the cabinet for selecting a desired irradiation mode to let a certain amount of the light-emitting diodes light up or go out.

Meanwhile, the above-mentioned objects can be fulfilled by the characteristics described in claims 1 and 12. Advantageous design features are stated in the subordinate claims:

### BRIEF DESCRIPTION OF THE FIGURES

The accomplishment of this and other objects of the invention will become apparent from the following descriptions and its accompanying figures of which:

FIG. 1 is a perspective view of a first embodiment of the invention;

FIG. 2 is a cutaway view of the first embodiment of the invention;

FIG. 3 is a perspective view of a second embodiment of the invention;

FIG. 4 is a perspective view of a third embodiment of the invention;

FIG. 5 is a cutaway view of an embodiment of an irradiation unit of the invention;

FIG. 6 is a cutaway view of another embodiment of the irradiation unit of the invention;

FIG. 7A through 7D are the irradiation unit in strip-shaped arrangement according to the invention with light-emitting diodes of different wavelength;

FIG. 8A through 8C are the irradiation unit in planar arrangement according to the invention with light-emitting diodes of different wavelength; and

FIG. 9 is a block diagram of a control circuit of the invention.

### DETAILED DESCRIPTION OF THE PREFERRED EMBODIMENT

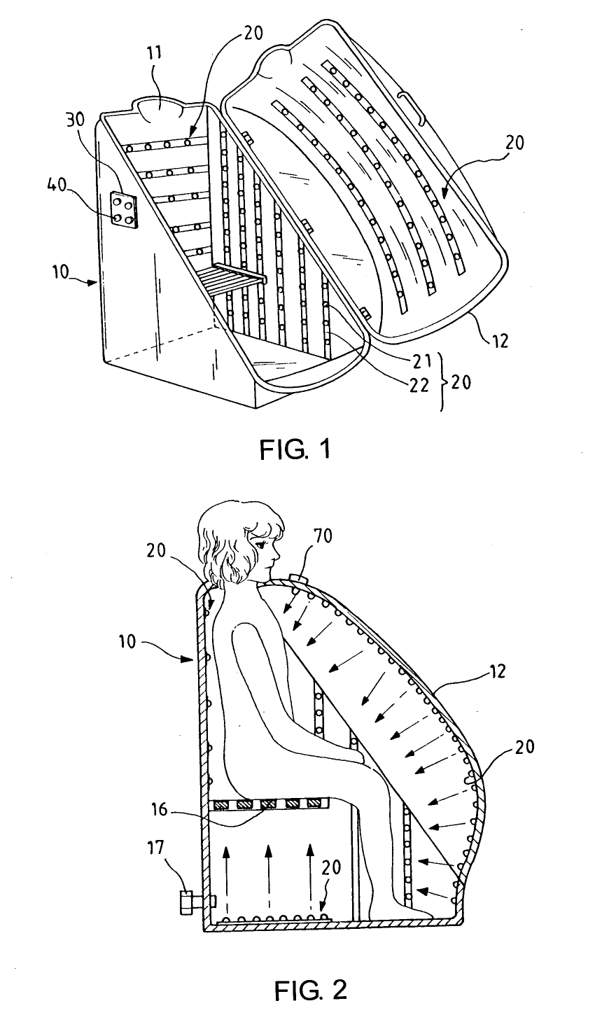

First of all, referring to FIGS. 1 and 2, the invention involves a vertical type cabinet 10 for receiving a user's body. The cabinet 10 includes a through hole 11 through which the user's head can be extended out of the cabinet 10. In accordance with different requirements, the cabinet 10 can be made of material selected from a group consisting of fiberglass-reinforced plastics (FRP), wood, plastics, acrylonitrile butadiene styrene (ABS), and metal. In addition to the main body, the cabinet 10 further includes a door 12 for opening and closing thee cabinet 10. The door 12 must not be restricted to one piece type.

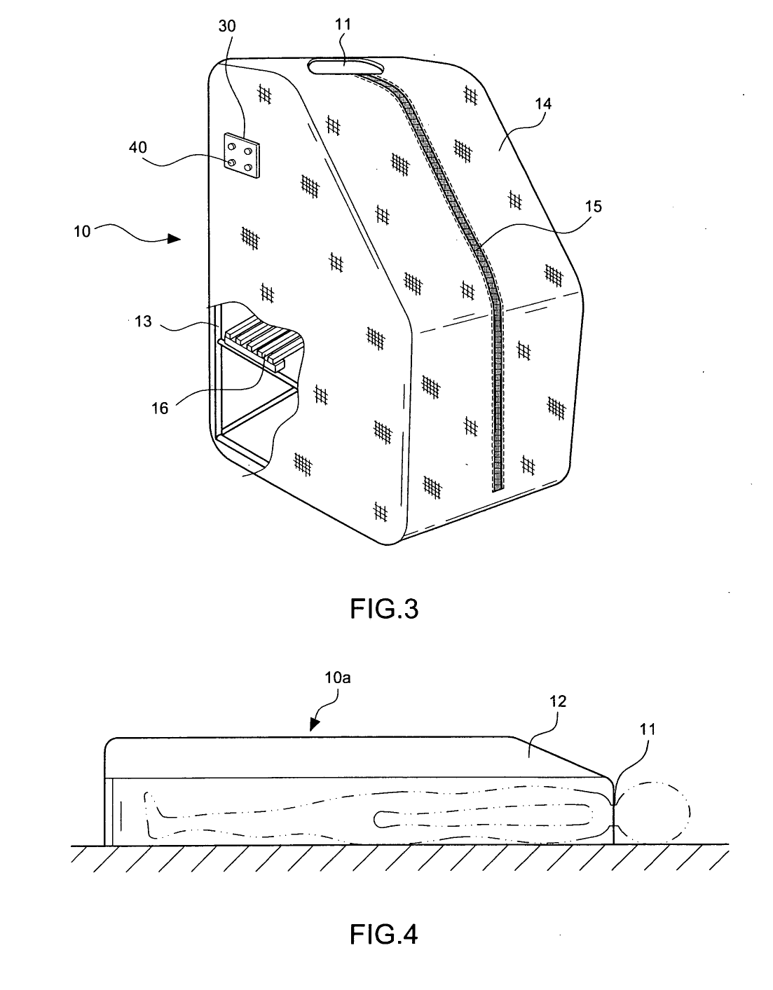

As shown in FIG. 3, the cabinet 10 can be constructed by a steel framework 13 covered with a soft covering 14. Similarly, the soft covering 14 is provided with a through hole 11 at a top side thereof. Besides, a zipper 15 is disposed at a front side thereof. The zipper 15 can be pulled downward from the through hole 11 for opening the cabinet 10 to create an access thereto.

Again, referring to FIGS. 1 and 2, the vertical type cabinet 10 includes a seat pad 16 for the user sitting thereon. So is a cabinet 10 for the light irradiation is completed. Thereafter, the cabinet 10 is fitted with an irradiation light source. In this embodiment in accordance with FIGS. 1 and 2, a plurality of light-emitting diodes 21 with a certain wavelength is electrically coupled to a circuit substrate 22, thereby creating an irradiation unit 20. A plurality of irradiation units 20 is fitted to at least one side of the inner wall of the cabinet 10. Alternatively, the irradiation units 20 can be installed at the inner wall of the right, the left, the rear, and/or the bottom side of the cabinet 10 as well as the inner wall of the door 12. However, the installation of the irradiation units 20 should not be restricted thereto. The irradiation units 20 can be arranged in a strip shape, but it should not be restricted thereto, either. That is, they can also be arranged in a planar shape.

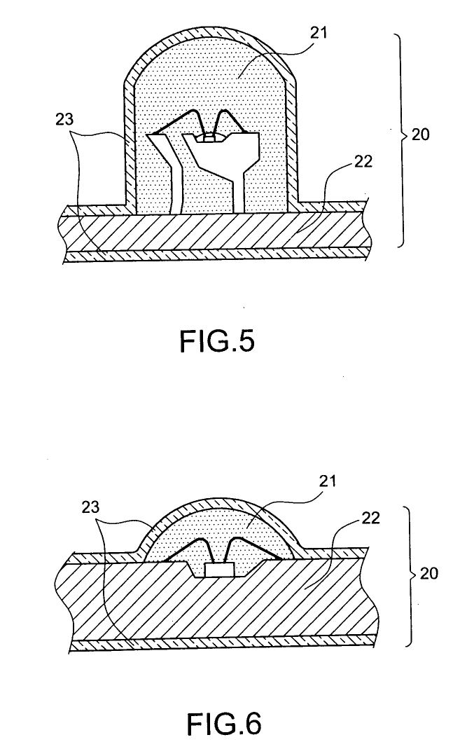

As shown in FIG. 5, the circuit substrate 22 of the irradiation unit 20 is constructed as a flexible circuit board. The light-emitting diodes 21 are mounted on the surface of the circuit substrate 22 and electrically coupled thereto. In this way, the rear side of the irradiation units 20 can be stuck to the predetermined position of the inner wall of the cabinet 10. Since they are mounted on the flexible circuit board, they can be disposed on an arched surface.

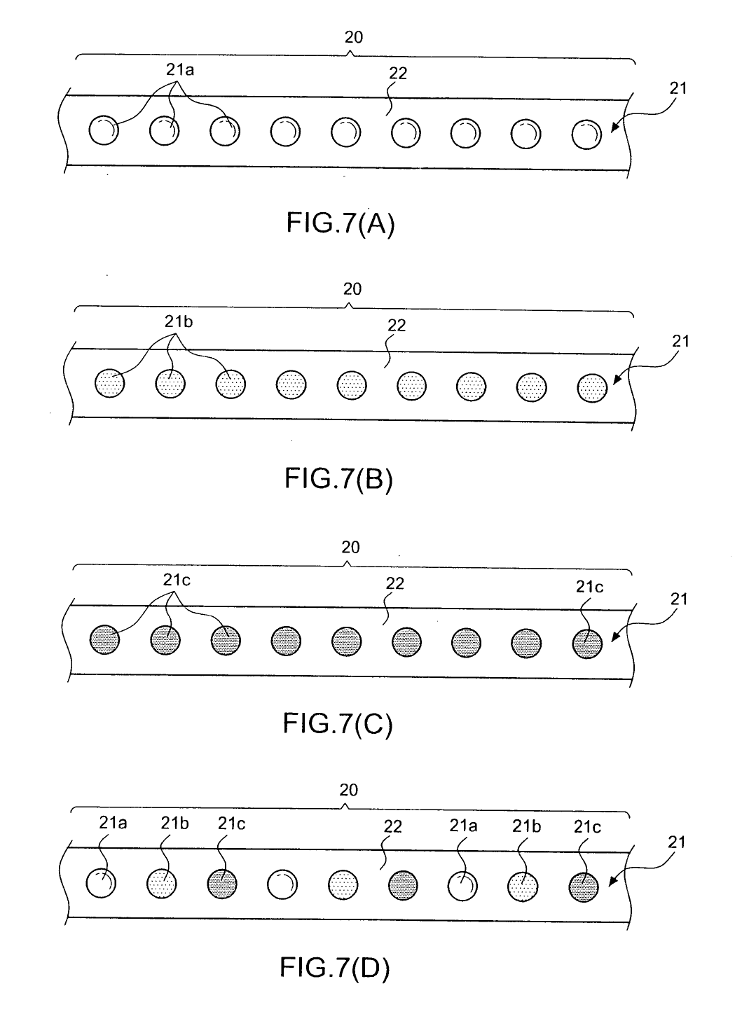

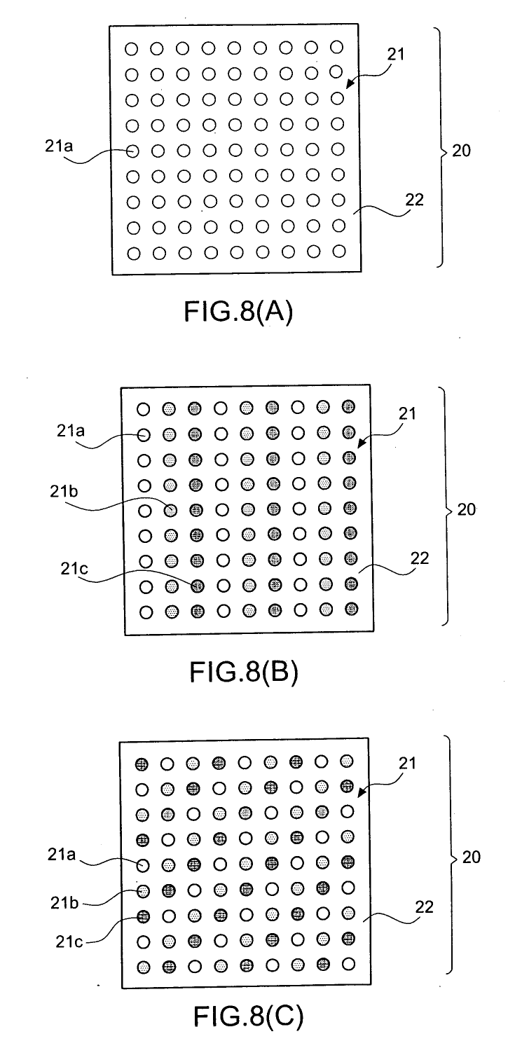

Of course, the irradiation unit 20 can be designed in accordance with FIG. 6. The circuit substrate 22 is constructed as a hard circuit board. The light-emitting diodes 21 are directly packaged to the surface of the circuit substrate 22 and electrically coupled thereto. No matter whether the circuit substrate 22 is a flexible or a hard circuit board, the irradiation unit 20 can be covered with a waterproof layer 23 made of transparent waterproof glue for protecting the light-emitting diodes 21 of the irradiation units 20 as well as the circuit substrate 22 from moisture. Referring to FIG. 7A through 7D, an applicable embodiment of the irradiation unit 20 is shown. As shown in FIG. 7A, the light-emitting diodes 21a on the circuit substrate 22 have a first wavelength. As shown in FIG. 7B, the light-emitting diodes 21b on the circuit substrate 22 have a second wavelength. As shown in FIG. 7C, the light-emitting diodes 21c on the circuit substrate 22 have a third wavelength. As shown in FIG. 7D, the light-emitting diodes 21a, 21b, 21c are arranged on the circuit substrate 22 in an alternating manner. In use, one of different irradiation modes can be chosen in accordance with different requirements. Referring to FIGS. 8A through 8C, a planar type irradiation unit 20 is shown. As shown in FIG. 8A, the light-emitting diodes 21a with the first wavelength are mounted on the planar circuit substrate 22. As shown in FIG. 8B, the light-emitting diodes 21a, 21b, 21c are arranged in rows on the circuit substrate 22 in an alternating manner. Referring to FIG. 8C, a staggered arrangement of the light-emitting diodes 21a, 21b, 21c on the circuit substrate 22 is shown. In use, one of different irradiation modes can be chosen in accordance with different requirements for ensuring an optimal irradiation effect.

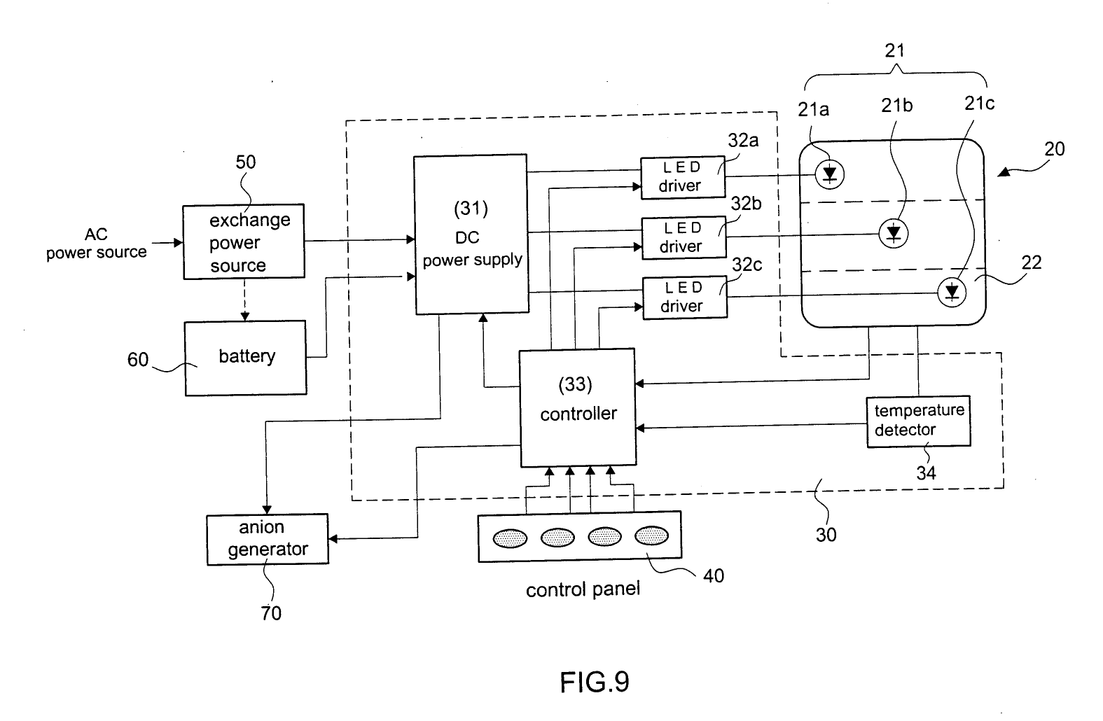

As shown in FIG. 9, the aforementioned irradiation unit 20 requires an LED control circuit 30 to supply power and to activate the light-emitting diodes 21 on the circuit substrate 22. The LED control circuit 30 includes a direct current 31, at least one LED driver, a controller 33, and a temperature detector 34.

The direct current 31 is used to feed the required power to the light-emitting diodes 21 on the circuit substrate 22. The direct current 31 is obtained by an exchange type power source 50 that changes an alternating current into a direct current of 1.5 V-4.5 V. Alternatively, the direct current 31 can be directly fed by a battery 60 in the cabinet 10. The battery 60 can be a secondary battery that can be charged by the exchange type power source 50.

In the embodiment according to FIG. 9, three LED drivers 32a, 32b, 32c are employed and interposed between the direct current 31 and the circuit substrate 22 for actuating the light-emitting diodes 21a, 21b, 21c, respectively.

The controller 33 is coupled to a control panel 40. As shown in FIG. 1, the control panel 40 is installed on an external side of the cabinet 10. The LED control circuit 30 is disposed within the housing of the control panel 40. Referring back to FIG. 9, the control panel 40 feeds the control signals to the controller 33 for controlling one of the LED drivers 32a, 32b, 32c to let the corresponding light-emitting diodes 21a, 21b, 21c light up.

Moreover, a temperature detector 34 is interposed between the circuit substrate 22 and the controller 33 for monitoring the temperature of the light-emitting diodes 21 when they light up, thereby protecting the human skin from the overtemperature. When the temperature of the light-emitting diodes 21 exceeds a predetermined temperature, the controller 33 closes all of the light-emitting diodes 21 for ensuring a better safety in use.

In addition, as shown in FIGS. 2 and 9, an anion generator 70 is installed in close vicinity to the through hole 1 1 of the cabinet 10. Meanwhile, the anion generator 70 is controlled by the control panel 40 such that the anion generator 70 creates anions by means of the point discharge. In this way, the user exposed to the irradiation can inhale the air purified by the released anions. So, the invention ensures an effective purification of air, cleanses the residue and dirt in skin, and restores the moisture of skin.

Referring again to FIG. 2, a steam inlet 17 is installed near the bottom of the cabinet 10 for feeding steam to the cabinet 10. In this way, the phototherapy cabinet 10 can serve a spa facility. The aforementioned irradiation unit 20 is covered with a waterproof layer 23 so that a desirable protection of the irradiation unit 20 from steam and moisture can be guaranteed. The phototherapy cabinet provided with steam treatment purpose is only suitable for business localities rather than for the household use. That is because steam pipes and a steam generator are necessary for this purpose. Accordingly, the steam inlet 17 is optionally installed for special use.

As shown in FIGS. 1 and 2, the user sits on the seat pad 16 in the cabinet 10. Then, one of buttons on the control panel 40 can be compressed to select the desirable irradiation unit 20 of different intensity and wavelength. For example, the first wavelength 300-330 nm is intended for ultraviolet rays, the second one 630-660 nm for infrared rays, and the third one over 860 um for invisible rays. Of course, a fourth wavelength of 470 nm for blue rays can be added to the invention. This won't be more described hereinafter. Each light wave has its own function, and a suitable one should be chosen by a professional physician. This doesn't belong to the object of the invention so that no further descriptions are given hereinafter.

Referring again to FIG. 4, the cabinet 10a can alternatively be designed in a horizontal type. The seat pad 16 intended for the cabinet 10 is replaced by a lying pad (not shown). The other components remain unchanged.

The invention utilizes a horizontal and vertical type cabinet 10 in which the irradiation units 20 are installed. Meanwhile, the LED control circuit 30 is used to actuate the light-emitting diodes 21 of different wavelength. The technology in the field of light-emitting diodes 21 has been mature and stable. Meanwhile, they have features of small-size and power-saving effect. So, the invention employs these features to enable that people can take sunbath at any moment and everywhere. Besides, the phototherapy of the invention can deliberately protect the human skin from exposure to harmful light rays. Accordingly, the use of the invention is much saver than the natural sunbath.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A light power irradiation treatment apparatus comprising:
a) a cabinet adapted to receive the user's body, a through hole being formed at a top side of the cabinet to allow the user to extending his head out of the cabinet;
b) a plurality of light-emitting diodes (LEDs) emitting light of different wavelength, LEDs being electrically coupled to a circuit substrate to form an irradiation unit, a plurality of irradiation units being mounted on the inner wall of the cabinet, thereby creating at least one planar irradiation light;
c) an LED control circuit adapted to supply power and actuate the light-emitting diodes on the circuit substrate; and
d) a control panel mounted on the surface of the cabinet for selecting a desired irradiation mode to let a certain amount of the light-emitting diodes light up or go out.

2. The light power irradiation treatment apparatus as recited in claim 1 wherein the cabinet is designed in a vertical position with the through hole at the top thereof, and wherein a seat pad is disposed within the cabinet.

3. The light power irradiation treatment apparatus as recited in claim 1 wherein the cabinet is designed in a horizontal position with the through hole at one side thereof.

4. The light power irradiation treatment apparatus as recited in claim 1 wherein the cabinet is made of steel with a door to create an access to the cabinet.

5. The light power irradiation treatment apparatus as recited in claim 1 wherein the cabinet is made of a steel framework covered with a soft covering, and wherein the soft covering also includes a through hole at a top side thereof with a zipper disposed at a front side thereof.

6. The light power irradiation treatment apparatus as recited in claim 1 wherein the circuit substrate of the irradiation unit is selected from a hard circuit board, a flexible circuit board or a combination thereof.

7. The light power irradiation treatment apparatus as recited in claim 6 wherein the irradiation unit includes a plurality of light-emitting diodes that are arranged on a strip-shaped circuit substrate, a planar circuit substrate or on a combination thereof.

8. The light power irradiation treatment apparatus as recited in claim 1 wherein the irradiation unit further includes a waterproof layer on the surface thereof.

9. The light power irradiation treatment apparatus as recited in claim 1 wherein an anion generator is installed in close vicinity to the through hole of the cabinet.

10. The light power irradiation treatment apparatus as recited in claim 1 wherein a steam inlet is provided in close vicinity to the bottom side of the cabinet for feeding steam to the cabinet.

11. The light power irradiation treatment apparatus as recited in claim 1 wherein the LED control circuit includes:
a) a direct current adapted to feed the required power to the light-emitting diodes on the circuit substrate;
b) at least one LED driver interposed between the direct current and the circuit substrate for actuating corresponding light-emitting diodes.
c) a controller coupled to the control panel for controlling the LED drivers to let a certain amount of the light-emitting diodes with different wavelength light up; and
d) a temperature detector interposed between the circuit substrate and the controller for monitoring the temperature of the light-emitting diodes when they light up.

12. A light power irradiation treatment apparatus comprising:
a) a cabinet adapted to receive the user's body, a through hole being formed at a top side of the cabinet to allow the user to extending his head out of the cabinet;
b) a plurality of light-emitting diodes (LEDs) emitting light of at least two different wavelengths, LEDs being electrically coupled to a circuit substrate to form an irradiation unit, a plurality of irradiation units being mounted on the inner wall of the cabinet, thereby creating at least one planar irradiation light;
c) an LED control circuit adapted to supply power and actuate the light-emitting diodes on the circuit substrate; and
d) a control panel mounted on the surface of the cabinet to allow the user to select a desired irradiation mode to let a certain amount and wavelength of the light-emitting diodes light up or go out.

13. The light power irradiation treatment apparatus as recited in claim 12 wherein the light-emitting diodes of each irradiation unit have the same wavelength and light color, while the irradiation units with different wavelength and light color are mounted on the inner wall of the cabinet.

14. The light power irradiation treatment apparatus as recited in claim 12 wherein the light-emitting diodes of each irradiation unit have at least two wavelengths and light colors, and wherein the light-emitting diodes are arranged on the circuit substrate in a staggered manner.
